(19) United States
(12) Patent Application Publication
(10) Pub. No.: US 2001/0021994 A1
(43) Pub. Date: Sep. 13, 2001

(54) Television

(75) Inventor: Jason M. Nash, Portsmouth (GB)

Correspondence Address: Corporate Patent Counsel, U.S. Philips Corporation, 580 White Plains Road, Tarrytown, NY, 10591, US

(73) Assignee: U.S. PHILIPS CORPORATION

(21) Appl. No.: 09/801,067

(22) Filed: Mar. 7, 2001

(30) Foreign Application Priority Data
Mar. 10, 2000 (GB) 0005727.3

(51) Int. Cl. G06F 3/00; H04N 7/025

(52) U.S. Cl. 725/42; 725/36; 725/34; 725/46

(57) ABSTRACT

A television system which enables advertisements to be targeted at viewers who have a particular interest in the products or services being promoted by the advertisement comprises reviews from a plurality of reviewers (101-1 to 101-n) commissioned by the advertiser (100) and alternatively or additionally by independent reviewers (103-1 to 103-n). These reviews are encoded into a data channel associated with the advertisement. A product rating decoder (106) is provided in a receiver (105) which decodes the data in the data channel and selects advertisements for display based on the data and a user profile generated either explicitly by the user entering preferences via a user interface (109) or implicitly by monitoring the type of programme selected for viewing by the user.

The invention relates to a television system and to television transmission apparatus and to television receiving apparatus for use in such a system.

Such a system and transmission and receiving apparatus have been disclosed in UK patent application No. 9922765.4 (PHB34400). As disclosed in that application a television system comprises a plurality of television programme sources and an associated database which contains data concerning the programmes for an Electronic Programme Guide (EPG) which is to be transmitted to a receiving device. Additionally a critics database which contains ratings by individual critics forming a panel of critics which review a given type of programme, for example sport, music, drama, current affairs and the like is provided and the ratings of individual critics are transmitted together with the EPG data. The ratings of individual critics are kept separate and are used in the receiving device for predicting which programmes are likely to be of interest to the viewer.

By making the rating of a programme by one or more of a panel of critics, that is a group of critics assembled to give their opinions on a particular range or ranges of programmes, one of the factors on which the programme selection and/or suggestion is made, those programmes which are highly rated by one or more of the critics making up the panel may be suggested to the viewer even if they do not satisfy other selection criteria. By having a panel of critics the opinion of one critic, with whom the viewer may or may not be sympathetic, will not become dominant. By encoding and transmitting the ratings of the critics individually, however, the processor can be arranged to give a greater weight to the rating of a particular critic if the viewer's opinion tends to coincide with that of a particular critic, although the opinions of the other critics can still be taken into account, perhaps with different individual weightings.

It is an object of the invention to enable the provision of a method of presenting information to a viewer which contains both material which has been explicitly gleaned from either the viewer's viewing habits or direct inputs by the viewer and material which may be inferred as being of possible interest to the viewer but outside the normal viewing habits.

The invention provides a television system comprising television transmission apparatus, a television transmission medium, and one or more television receiving devices, wherein the television transmission apparatus includes means for transmitting video, audio, and data signals, said data signals comprising data representing television advertisement information concerning advertisements which are to be transmitted, and said television receiving device(s) comprising a data decoder for decoding said transmitted data, a memory for storing at least some of the data received by said receiving device(s), and a processor arranged to examine the stored data to determine advertisements which may be of interest to a viewer based on information entered by the viewer and/or information derived from monitoring the viewing habits of the viewer, wherein the data signals include data provided by a plurality of reviewers representing individual ratings of advertisements or the products or services promoted by said advertisements to be transmitted and the processor is arranged to select or suggest advertisements for viewing by taking into account the ratings of one or more of the reviewers.

Subjective information is often employed by people as a means of making choices, for example when selecting products to buy, music to listen to, or TV programmes to watch. The subjective information may come in the form of a review by professional critic, as found in consumer magazines, TV listings, newspapers etc., or a recommendation from a friend or colleague. Choosing options on the basis of other people's opinions is a powerful selection mechanism and is known as social filtering. Accordingly, the present invention is a very powerful mechanism for tailoring advertisements to a particular viewer.

The present invention uses a similar technique to that disclosed in UK Patent Application No. 9922576.4 (PHB34400) but employs it with respect to advertisements rather than to programmes. This gives advantages both to the advertiser and the viewer in that the advertisement is targeted to the interested party. Thus the advertiser can ensure that a particular advertisement is brought to the attention of those particularly interested in the product or service being advertised and the viewer can see preferentially those advertisements for products or services which are of particular interest or which persons or organisations he or she respects endorse.

By supplying subjective rating information of the products featured in adverts, advertisers can use the information as a means of convincing the user to buy their product, and users can use it to aid them in their evaluation of the product. Also the rating information may be employed by a software agent, in conjunction with details of the user's preferences, to automatically select potentially interesting advertisements for the user to view. A simple example of this may be that an agent learns that the user likes cars, motoring programmes are regularly watched, and so the agent considers all advertisements featuring cars, but only presents the user with advertisements where the cars get good ratings, omitting the bad ones. Another possible scenario is that the agent learns that the user has a favourite actor, sports personality or motoring journalist and so it selects advertisements which feature products reviewed by those individuals.

The subjective product rating information may originate from a variety of sources, one source being the advertisers supplying the advertisement who may have paid various well known individuals to review their product. Other sources might include consumer associations such as Which, journalists specialising in topics such as motoring, consumer electronics, financial matters and the like or even local government trading standards agencies.

By making the rating of an advertisement by one or more reviewers of the quality of the advertisement or the quality of the product or service promoted by the advertisement one of the factors on which the advertisement selection and/or suggestion is made, those advertisements which are highly rated by one or more of the reviewers may be suggested to the viewer even if they do not satisfy other selection criteria. By having a plurality of reviewers the opinion of one personality or organisation, with whom the viewer may or may not be sympathetic, will not become dominant. By encoding and transmitting the ratings of the reviewers individually, however, the processor can be arranged to give a greater weight to the rating of a particular reviewer if the viewer's opinion tends to coincide with that of a particular critic, although the opinions of the other reviewers can still be taken into account, perhaps with different individual weightings. Clearly the reviewers are not necessarily exclusive, that is a particular reviewer may serve to review advertisements for different products or services.

The invention further provides television transmission apparatus comprising means for entering individual ratings from a plurality of reviewers into a database for at least some of the advertisements to be transmitted by that or other television transmission apparatus and receivable by one or more receiving device(s), means for encoding the ratings for transmission with other data associated with the programmes, and means for transmitting the data.

The television transmission apparatus includes means for entering individual ratings of programmes from a plurality of reviewers. The ratings of each of the reviewers are kept separate and transmitted separately from those of the other reviewers of the advertisement. This enables each of the opinions to be considered separately within receivers of the data transmitted. The reviewer may be an individual or the rating may be given to a product or service advertised by consumer groups.

The data may be multiplexed with one or more of the television programmes or advertisements being transmitted by the transmission apparatus.

This enables the data to be gathered at the receiver while the user is viewing and/or recording programmes or advertisements. This is essentially the same as current teletext and EPG transmissions with analogue television transmissions where the data is transmitted during the vertical blanking interval and in this way conventional television data encoders and data inserters can be used in the transmission apparatus and conventional data decoders can be used in the receiving devices. With digital television transmissions it is also possible to multiplex the data with the data streams representing the video and audio signals for a given programme.

Alternatively the data may be transmitted on a separate channel dedicated to data transmission.

If this separate channel is an analogue television channel dedicated to data a larger amount of data may be transmitted more rapidly since the whole television field is available for data transmission and not merely the vertical blanking interval. Thus, depending on the memory capacity in the receiving device, data relating to a greater number of channels can be transmitted or a more in depth description of forthcoming programmes can be transmitted. In addition programme schedules looking further into the future can be transmitted without the transmission cycle becoming unduly extended. In this case it is of course necessary to arrange that the data is captured either when programmes are not being viewed or recorded or to provide a separate selection circuit which is capable of receiving the data at the same time as a programme is being viewed on another channel.

The separate channel dedicated to data transmission may take various other forms such as an analogue channel dedicated to data but not of TV format and having either a higher or lower bandwidth than a standard TV channel. If such a channel has a lower bandwidth then the transmission cycle for a given quantity of data will, of course, be increased. A further possibility with the transmission of television programmes and associated data digitally is to allocate a multiplex to the data and this will normally allow an increased amount of data to be transmitted or provide a shorter transmission cycle. In addition an entirely different transmission medium may be used for the data transmission, for example the internet or a satellite channel.

From the above it will be apparent that it is not essential that the dedicated data channel has a high bandwidth, particularly if the receiving device has a large memory capacity and can be left in a standby condition, when not being viewed, such that the data in the data channel can be captured and stored for use when the viewer wishes to access the database or select (or have selected) an advertisement for viewing.

The invention further provides a television receiving device for receiving television advertisements and data signals transmitted by television transmitting apparatus, said receiving device comprising a data decoder for decoding said transmitted data, a memory for storing at least some of the data decoded by said data decoder, and a processor arranged to select and/or suggest advertisements for a viewer to receive, said selection and/or suggestion being based on information entered by a user and/or derived from monitoring the viewing habits of the user, in which the data signals include data representing the individual ratings of a particular program by a plurality of reviewers and that said selection is further based on the rating accorded by one or more of the reviewers.

In the television receiving device according to the invention a memory stores data relating to advertisements which will be transmitted at a later time and this data includes the rating of the programmes by a plurality of reviewers. The ratings of individual reviewers are stored separately (associated with the relevant advertisement) so that the processor in the receiving device has access to each reviewer's individual rating for each advertisement. The processor uses the data received and stored together with a user profile, which includes data defining the users interests and habits as far as viewing or recording advertisements is concerned, in order to determine which of these advertisements which are to be transmitted are likely to be of interest to the user. The presentation to the user may be made in a number of different ways. For example, a list of advertisements which are likely to be of interest may be generated and displayed when the receiving device is switched on. Alternatively, the list may be displayed when the user calls it up using a remote control device. Another possibility is to cause a message to be displayed when an advertisement of possible interest is about to start or to switch the receiver from a stand by state to a fully on state when an interesting programme is about to start.

A remote control device may be provided to enable the user to select channels to be received and other functions of the receiver, the remote control device being arranged to transmit an identification signal to the receiving device specific to the user and the receiving device includes means for receiving the identifying signal and thereby determining the identity of the user.

By this means the processor can verify that the user is the person whose user profile is contained within the receiving device.

The remote control device may include means for transmitting one of a plurality of identification signals, the particular identification signal transmitted depending on the person currently using the remote control device.

If the receiving device is able to store a different user profile for a number of different users, for example different members of a family residing at the same address and using a common receiving device, then it can use the user profile of the person currently using the receiving device. Clearly the profiles of different members of a family may be significantly different when the family includes both male and female members and different generations such as parent and child. There are many possibilities for enabling the remote control device to emit a different identification signal for different users. One possibility is to provide it with a number of user identity keys which are labeled according to the user and which cause different identification signals to be generated. One of these keys is operated by the user to announce his or her identity and then the other functional keys can be used. The receiving device then uses that user's profile until another user identification key is operated. Another possibility is the use of an automatic recognition means for example a fingerprint sensor, on the remote control device. The fingerprint sensor would identify the user and cause the appropriate identification signal to be transmitted. It will be understood that these are only two examples of many possibilities for identifying to the television receiving device the identity of the user.

As an alternative a plurality of remote control devices may be provided, each of which is arranged to transmit a different identification signal and each of which is identifiable to the users to enable each user to use a particular one of the remote control devices.

This enables each of the remote control devices to be of a simpler form since only a single identification signal needs to be generated in each remote control unit. It will be apparent that only a small number of different identification signals are required, typically less than eight since there will be a limited number of users of a television receiving device in a single household and the identification signals can be re-used in other households. The identification signal may merely be a number which is allocated to each remote control device. The identification of the respective remote control devices for the users may take any convenient form, for example different colours or labels on the devices or by making the remote control devices of different shapes such as characters from cartoons or imitations of other objects.

The television receiving device may be arranged to receive data signals transmitted on a different channel from television programmes and comprise first channel selection means for selecting a programme channel and second channel selection means for selecting a data channel.

In an analogue television context full channel transmission of data allows a greater quantity of data to be sent while keeping the cycle time within reasonable limits since the data can occupy the full field and not just the vertical blanking interval. It will be appreciated that the data is sent serially and once all the data has been sent then the cycle of transmission is repeated. Clearly the length of this cycle is dependent on the quantity of data to be transmitted and the rate at which the data is transmitted. While the transmitted data can be stored indefinitely in the receiving device it is necessary that a full cycle is completed while the receiving device is switched on in order to enable all the data to be stored unless the receiving device has a standby mode in which data is captured and stored when the rest of the receiver is switched off. Also the data will be updated on occasions and it is desirable that the updated data is transmitted without substantial delay. By providing two selection means the receiving device can keep the data stored up to date by monitoring the data channel while the user is watching one of the programmes and hence it is not necessary to periodically tune to the data channel and thus interrupt viewing of the programmes.

Thus the term “television receiving device” does not only include a standard television receiver but also includes any device which is capable of receiving television signals, for example a set top box or a video recorder, even if it does not include a display device and/or audio reproduction means. As another example the television receiving device might be a personal computer having a TV card, in which case the data channel might be the internet which enables a large quantity of data relating to the available television programmes and associated advertisements to be downloaded into memory and highly complex operations to be performed on that data with the large processing power contained in personal computers. Similarly, it has been proposed to connect set top boxes to the internet and to include such facilities in otherwise conventional television receivers,

If the television receiving device is a video recorder then it can record for later viewing the advertisements which are of interest to the viewer and are transmitted when the viewer is not watching the television set or is watching another programme.

The invention still further provides a method of selecting television advertisements for viewing and/or recording comprising the steps of;

i) receiving data representing advertisements to be transmitted, said data indicating at least the date, and time of transmission of the advertisement and the advertisement type,

ii) receiving data representing a rating given to advertisements and/or the products or services promoted by the advertisement by individual reviewers or organisations,

iii) storing at least some of the data,

iv) entering and/or generating and storing a user profile indicating the type of programmes the user prefers to view, and

v) selecting a programme for viewing and/or recording using the stored data and the user profile.

Using such a method enables a television receiving device to select advertisements which may be of interest to a user. By including ratings of programmes from a plurality of reviewers and keeping the individual ratings of each of the reviewers separate it is possible to give a greater weighting in the selection criteria to the rating of a reviewer with whom the user has the greatest sympathy.

The selection step may comprise providing a suggestion to the user as to which current or future advertisements are likely to be of interest.

Thus the receiving device may be arranged to provide a list for suggested viewing for the day or evening when the receiving device is switched on or when requested to do so by the user entering requests using the remote control device. The user profile may be generated and/or refined by monitoring those advertisements the user chooses to view or record and may for example give greater weight to advertisements which are selected for recording as being more likely to be of a particular interest.

Over a period of time an accurate user profile can be build up by monitoring those advertisements which are watched or recorded and this profile can be continuously refined as the viewer's tastes change or develop. This, however, does mean that on initial use the receiving device has no knowledge of the viewer's interests and hence suggestions for viewing will be non-existent or random. In order to overcome this problem it is possible for the viewer to enter some initial information as to his or her interests, for example using a menu and selection scheme by entering choices using a remote control device. This initial profile is then continuously updated by monitoring those programmes watched or recorded.

The method may further include the steps of storing user profiles for a plurality of users, identifying the current user, and using the profile of the identified user in the programme selection.

This enables advertisements which are likely to be of interest to one of several users of a particular television receiving device such as a television set in the living room of a home. In this situation the television set may be viewed by parents and children of both sexes who are likely to have widely different interests and consequently advertisements which are of interest to one may have no interest for other members of the family.

The above and other features and advantages of the invention will be apparent from the following description, by way of example, of embodiments of the invention with reference to the accompanying drawings, in which:

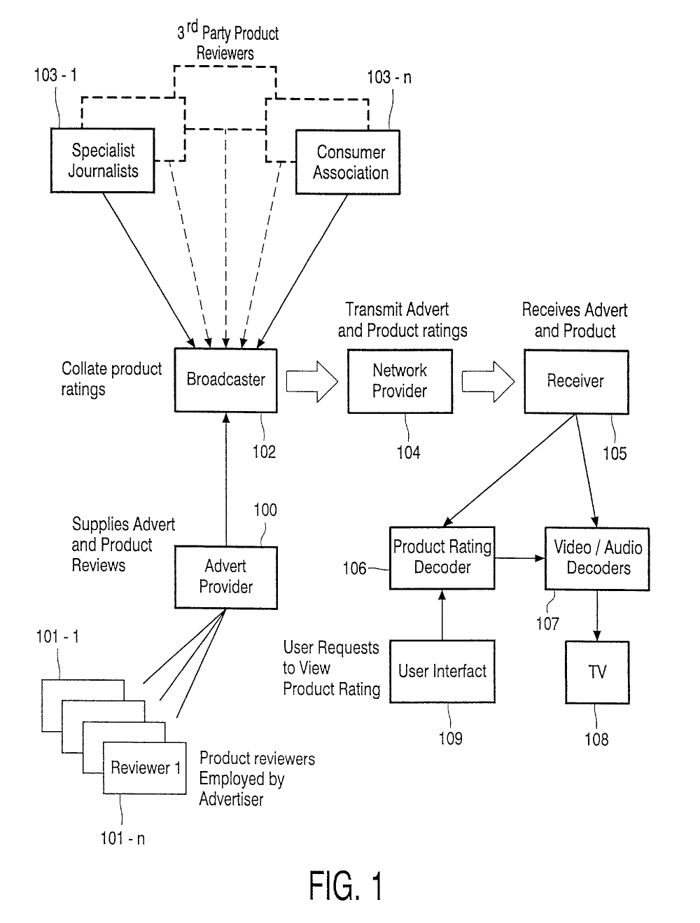

FIG. 1 shows in schematic form a first embodiment of a system for enabling advertisers to add information to their advertisements which enables those advertisements which are of interest to a viewer to be selected;

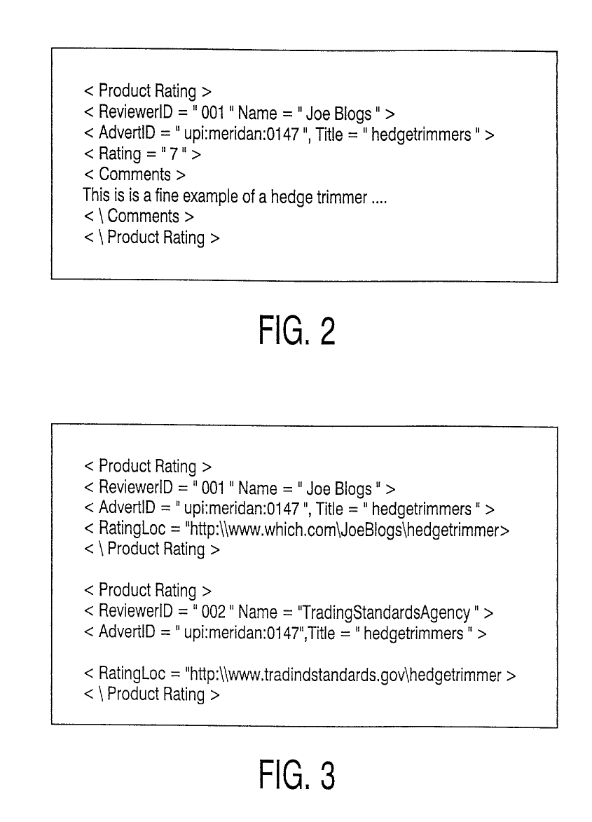

FIG. 2 illustrates a first example of product rating information to be transmitted with an advertisement;

FIG. 3 illustrates a second example of product rating information to be transmitted with an advertisement; and

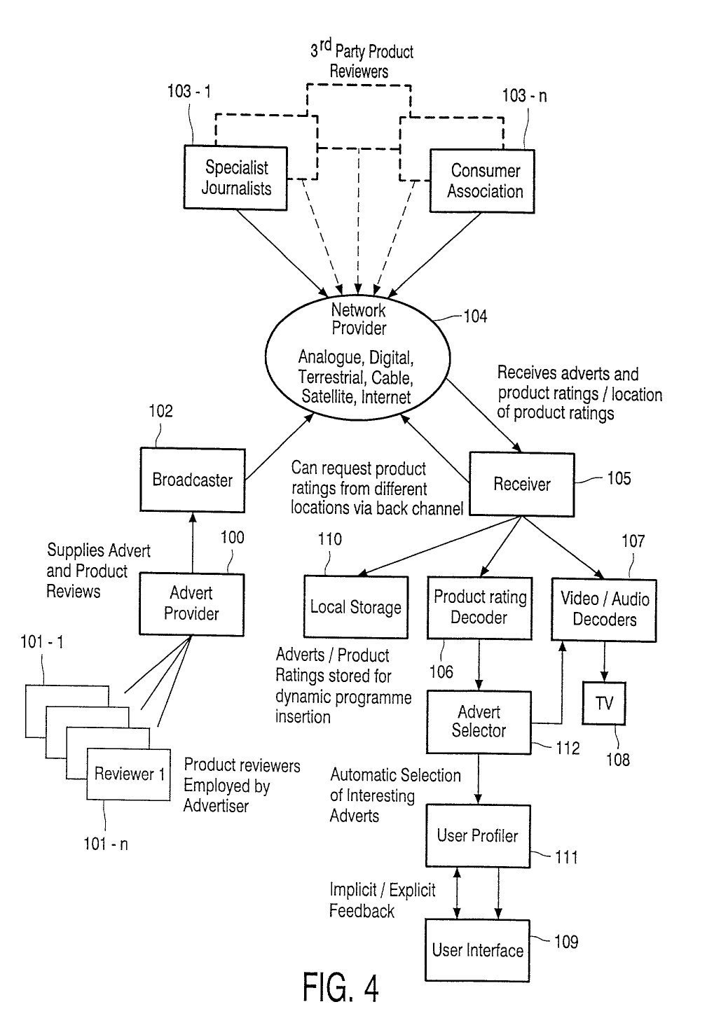

FIG. 4 shows in schematic form a second embodiment of a system for enabling advertisers to add information to their advertisements which enables those advertisements which are of interest to the viewer to be selected.

FIG. 1 shows a block 100 which represents the advertisement provider. A number of product reviews 101-1 to 101-n, produced by reviewers who are employed by the advertiser are fed into the advertisement provider. The advertisement provider 100 feeds to a broadcaster, represented by block 102, the advertisement which has associated with it a number of product reviews by the product reviewers employed by the advertiser. The broadcaster may also receiver a number of other product reviews which may be provided by specialist journalists, consumer associations, government departments or other sources, these are represented by the boxes 103-1 to 103-n. The broadcaster then collates the reviews both by the reviewers employed by the advertiser and the third party product reviewers. Reviews of third party product reviewers represent the views of person not directly associated with the advertiser. The broadcaster 102 will collate the product ratings and encode them for transmission with the signal containing the advertisement as data detailing the product ratings by the various reviewers. The advertisement and associated data is then transmitted via a network provider 104 to one of a plurality of receivers 105. The receiver has associated with it a product rating decoder 106 which decodes the data transmitted with the advertisement or alternatively via a separate data channel and cause the video and audio processors 107 within the receiver to process the advertisement and display it on a display screen 108. The product rating decoder 106 will also pass to the video and audio processors 107 the data which has been transmitted together with the advertisement so that the associated information can be accessed by the viewer. A user interface 109 is provided to enable the user to perform the various control functions necessary to operate the receiver. The product rating decoder 106 also monitors the user interface 109 to enable it to determine a user profile either explicitly by the user entering preferences in a set up procedure or implicitly by monitoring those advertisements the user selects for viewing or recording.

The arrangement described with reference to FIG. 1 enables subjective product rating information to be transmitted in conjunction with the advertisement, either on the same channel as the advertisement or via separate dedicated data channel and does not require a return channel to the broadcaster, advertiser or product or service supplier. This preserves the privacy of the viewer as there is no indication to a central data base as to which advertisements the viewer is watching or has selected.

FIG. 2 illustrates an example of product rating information which could be transmitted with the advertisement. The example product rating is encoded in pseudo extended mark up language (XML) and contains information concerning the identity of the reviewer, the advertisement to which the rating is linked, a numerical rating on a scale of 1 to 10, and a text comment.

If the receiver is equipped with a return or back channel then the product rating information need not be transmitted with the advertisement. In this case the only information which needs to be transmitted is the location of where to find the product rating information. As a result, there is no longer a requirement for the broadcaster or a third party to collate the information prior to transmission. Upon reception of an advertisement and the location of where to obtain the product rating information the user and/or system is free to down load the information should they or it choose. An example of the information which might be transmitted in this particular case is shown in FIG. 3. In FIG. 3, two ratings containing information relating to the identity of the reviewer, the advertisement to which the rating is linked and the location of where to obtain a product review are shown. In this particular instance the location is on the World Wide Web and thus available to anyone who has an internet connection.

Although the example product ratings shown in FIGS. 2 and 3 are readable by a human, the majority of the information is intended for the receiver, that is the reviewer identity, the advertisement identity, the reviewer's rating, the rating location. Only the text comment and the reviewer's name is intended for the user. It will be apparent that only the machine readable information is necessary and intended for enabling the system to select appropriate advertisements for viewing.

The provision of a back channel creates the possibility of other processes where the receiver is not directly informed where to obtain the rating information. For example, if the system has learnt that the user is a regular watcher of a particular motoring programme, on reception of an advertisement featuring a certain model of car, the system contacts the Web site of the motoring programme to determine whether they have reviewed that car. If so, the system will then retrieve the rating of the car given in the programme and use this information to determine whether the user would be interested in the advertisement. The system could then retrieve a text comment detailing the opinions of each of the programmes presenters regarding the car or even download an audio or video clip of the part of the programme where the car is reviewed, assuming that the receiver has local storage. However, this also requires that the advertisements are tagged to indicated what the subject matter is, for example golf, motoring, insurance etc. That is the data associated with the advertisement indicates the subject of the product or service being advertised.

If the receiver has no local storage and the advertisements are transmitted in real time with the programmes, the receiver might indicate that an advertisement may be of interest to the user by displaying a message on screen, or automatically displaying the favoured individual's comment on the product. Alternatively the receiver may automatically mute the volume for all advertisements and raise the volume when a potentially interesting advertisement is encountered.

The introduction of local storage in the receiver, for example in the form of a hard disc, allows for different delivery mechanisms to be employed. The advertisements may be downloaded directly to the local memory and dynamically inserted into programmes at regular intervals. In this case the receiver would be able to select and insert only those advertisements which are potentially interesting to the user and omit the rest. An overview of a more complex system equipped with local storage, a return channel to retrieve product reviews from different locations and with the ability to automatically select potentially interesting advertisements is shown in FIG. 4.

Those elements in FIG. 4 which correspond to elements in FIG. 1 have been given the same reference signs. In the arrangement shown in FIG. 4, the receiver in addition to receiving programmes and advertisements form the broadcaster via the network provider 104 is also able to communicate with the network provider. The receiver 105 is also connected to a local storage arrangement 110, which may for example be a hard disc that is capable of storing several hours of programmes and advertisements. The product rating decoder 106 receives inputs from both the receiver 105 and the local store 110 and is able to decode the data associated with the advertisements. The user interface 109 interacts with a user profiler 111. The user profiler may use explicit information which is entered by the user using the user interface or may use implicit data such as monitoring which programmes and/or advertisements the user watches and with what frequency. It may also monitor particular programmes but also types of programmes such as sport, motoring, fashion and the like. The user profiler 111 will feed the advertisement selector 112 to enable the advertisement selector to monitor those advertisements which match the user profile using the data transmitted with the advertisements.

The presence of a back or return channel can raise privacy issues regarding the sharing of information dealing with the user's preferences. This may not be of importance to some users, for example users of the internet accept this situation, but there are others who view the idea that a central authority would have access to details of their individual preferences as an invasion of their privacy. These people may not wish to have the return channel, but they can still have advertisements selected for them by means of the information that is transmitted with the advertisements. This information may be automatically read and interpreted by the user profiler 111 and advertisement selector 112. Depending on the functions built into the receiver the rating information can either be viewed directly by the user or correlated with the user's profile to select advertisements of potential interest via social filtering. Advertisers can employ the product ratings as a means of convincing the user to buy their product and if the user's receiver supports automatic advertisement selection ensure that their advertisements are targeted to the correct audience. This provides an incentive to the advertiser to incorporate the additional data with their advertisements.

In the arrangement shown in FIG. 4, the network provider can take many forms. For example it can be standard analogue or digital terrestrial television transmitters, cable TV networks or satellite delivery systems. In addition, the internet can be used, particularly for access to web sites which may have further information that is relevant to the particular advertisement. The data associated with the advertisement may well include the address of particular internet sites which have relevant additional information. The local storage unit 110 may take any convenient form but will typically be a hard disc. Hard disc drives are increasingly being proposed for use within television receivers for recording television programmes and can be arranged to include advertisements. They are presently capable of storing many hours of television programmes. User profiling may be carried out by the user entering information as to what particular topics are interesting to the user. Such explicit information may be entered by a set-up procedure in the receiver. This may be further refined by implicit monitoring by the user profiler 111 of which particular topics the user habitually watches. In this respect particular topics will include types of programmes such as sport, quiz shows, films, cookery programmes and the like and also a particular personalities for example a particular motoring correspondent or a particular cookery expert. Thus the user profiler 111 can provide the information to enable the advertisement selector 112 to select in an intelligent way the advertisements which are likely to be of interest to the user. In addition the advertiser will gain from having their particular advertisement targeted towards those users who are likely to be particularly interested in the product or service being promoted.

From reading the present disclosure, other modifications and variations will be apparent to persons skilled in the art. Such modifications and variations may involve equivalent features and other features which are already known in the art and which may be used instead of or in addition to features already disclosed herein. Although claims have been formulated in this Application to particular combinations of features, it should be understood that the scope of the disclosure of the present application includes any and every novel feature or any novel combination of features disclosed herein either explicitly or implicitly and any generalisation thereof, whether or not it relates to the same invention as presently claimed in any claim and whether or not it mitigates any or all of the same technical problems as does the present invention. The Applicants hereby give notice that new claims may be formulated to such features and/or combinations of such features during prosecution of the present application or of any further application derived therefrom.

1. A television system comprising television transmission apparatus, a television transmission medium, and one or more television receiving devices, wherein the television transmission apparatus includes means for transmitting video, audio, and data signals, said data signals comprising data representing television advertisement information concerning advertisements which are to be transmitted, and said television receiving device(s) comprising a data decoder for decoding said transmitted data, a memory for storing at least some of the data received by said receiving device(s), and a processor arranged to examine the stored data to determine advertisements which may be of interest to a viewer based on information entered by the viewer and/or information derived from monitoring the viewing habits of the viewer, wherein the data signals include data provided by a plurality of reviewers representing individual ratings of advertisements or the products or services promoted by said advertisements to be transmitted and the processor is arranged to select or suggest advertisements for viewing by taking into account the ratings of one or more of the reviewers.

2. Television transmission apparatus comprising means for entering individual ratings from a plurality of critics into a database for at least some of the advertisements or the products or services promoted by said advertisements to be transmitted by that or other television transmission apparatus and receivable by one or more receiving device(s), means for encoding the ratings for transmission with other data associated with the programmes, and means for transmitting the data.

3. Television transmission apparatus as claimed in claim 2 in which the data is multiplexed with one or more of the television programmes being transmitted by the transmission apparatus.

4. Television transmission apparatus as claimed in claim 2 in which the data is transmitted on a separate channel dedicated to data transmission.

5. A television receiving device for receiving television programmes and data signals transmitted by television transmitting apparatus, said receiving device comprising a data decoder for decoding said transmitted data, a memory for storing at least some of the data decoded by said data decoder, and a processor arranged to select and/or suggest advertisements for a viewer to receive, said selection and/or suggestion being based on information entered by a user and/or derived from monitoring the viewing habits of the user, in which the data signals include data representing the individual ratings of a particular advertisement or particular products or services promoted by the advertisements by a plurality of reviewers and that said selection is further based on the rating accorded by one or more of the reviewers.

6. A television receiving device as claimed in claim 5 in which a separate user profile is stored for each user so that when a particular user is identified suitable advertisements are selected and/or suggested.

7. A television receiving device as claimed in claim 5 or claim 6 in which a remote control device is provided to enable the user to select programmes and other functions of the receiver, wherein the remote control device is arranged to transmit an identification signal to the receiving device specific to the user and the receiving device includes means for receiving the identifying signal and determining the identity of the user.

8. A television receiving device as claimed in claim 7 in which the remote control device includes means for transmitting one of a plurality of identification signals, the particular identification signal transmitted depending on the person currently using the remote control device.

9. A television receiving device as claimed in claim 5 or claim 6 in which a plurality of remote control devices are provided, each of which is arranged to transmit a different identification signal and each of which is identifiable to the users to enable each user to use a particular one of the remote control devices.

10. A television receiving device as claimed in any of claims 5 to 9 for receiving data signals transmitted on a different channel from television programmes comprising first channel selection means for selecting a programme channel and second channel selection means for selecting a data channel.

11. A television receiving device as claimed in any of claims 5 to 10 which comprises a set top box.

12. A television receiving device as claimed in any of claims 5 to 10 which comprises a video recorder.

13. A method of selecting television advertisements for viewing and/or recording comprising the steps of:
i) receiving data representing advertisements to be transmitted, said data indicating at least the date, and time of transmission of the advertisement and the advertisement type;
ii) receiving data representing a rating given to programmes by an individual and/or an organisation;
iii) storing at least some of the data;
iv) entering and/or generating and storing a user profile indicating the type of advertisement of interest to the user; and
v) selecting a programme for viewing and/or recording using the stored data and the user profile.

14. A method as claimed in claim 13 in which the selection step comprises providing a suggestion to the user as to which current or future advertisements are likely to be of interest.

15. A method as claimed in claim 13 or claim 14 in which the user profile is generated and/or refined by monitoring those programmes the user chooses to view or record.

16. A method as claimed in any of claims 13 to 15 comprising the steps of storing user profiles for a plurality of users, identifying the current user, and using the profile of the current user in step v).
